(19) United States
(12) Patent Application Publication
(10) Pub. No.: US 2026/0163759 A1
(43) Pub. Date: Jun. 11, 2026

(54) TIME SYNCHRONIZATION FOR VIRTUAL NETWORKS

(71) Applicant: HEWLETT PACKARD ENTERPRISE DEVELOPMENT LP, Spring, TX (US)

(72) Inventors: Venkatachalam Swaminathan, Bangalore (IN); Chandru Ds, Bangalore (IN)

(21) Appl. No.: 19/073,195

(22) Filed: Mar. 7, 2025

(30) Foreign Application Priority Data
Dec. 11, 2024 (IN) 202441098111

(51) Int. Cl. H04L 12/46; H04L 7/00

(52) U.S. Cl. CPC H04L 12/4675; H04L 7/0008

(57) ABSTRACT

In some examples, a first electronic device includes an interface to communicate over a plurality of virtual networks. A memory stores a mapping between virtual stream identifiers and respective interface-virtual network combinations, where a virtual stream identifier identifies a communication stream over a virtual network. As part of a time synchronization process over the virtual network, a first time clock perform a lookup of the mapping using a first virtual stream identifier to retrieve an identifier of the virtual network. The first time clock adds the identifier of the virtual network to a timing message, and sends, over the virtual network, the timing message to a second electronic device that includes a second time clock to which the first time clock of the first electronic device is to be synchronized over the virtual network according to the time synchronization process.

### BACKGROUND

An electronic device in a distributed system of electronic devices includes a time clock that produces time, which can be wall-clock time or any other representation of time. Times produced by the time clocks in multiple electronic devices allows transactions occurring across the multiple electronic devices to be time-aligned with one another.

### BRIEF DESCRIPTION OF THE DRAWINGS

Some implementations of the present disclosure are described with respect to the following figures.

FIG. 1 is a block diagram of an arrangement includes including electronic devices having respective time clocks, according to some examples.

FIG. 2A and FIG. 2B are timing diagrams illustrating exchanges of timing messages according to a Precision Time Protocol (PTP), according to some examples.

FIG. 3 is a block diagram of an electronic device including a multi-virtual local area network (VLAN) time clock, according to some examples.

FIG. 4 is a flow diagram of a VLAN stream initialization process, according to some examples.

FIG. 5 is a flow diagram of a VLAN stream removal process, according to some examples.

FIG. 6 is a flow diagram of a timing message receipt process, according to some examples.

FIG. 7 is a flow diagram of a timing message transmit process, according to some examples.

FIG. 8 is a block diagram of an electronic device according to some examples.

FIG. 9 is a block diagram of a storage medium storing machine-readable instructions according to some examples.

FIG. 10 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

To maintain synchronization among time clocks (or more simply, “clocks”) in electronic devices in a distributed system, a time synchronization process can be employed. In some examples, the time synchronization process can be according to a time synchronization protocol such as the Precision Time Protocol (PTP) described by an Institute of Electrical and Electronics Engineers (IEEE) 1588 Specification.

PTP employs timing messages exchanged between electronic devices (or more specifically, between clocks of the electronic devices) to perform time synchronization. The timing messages are used to calculate offsets between clocks corresponding to delays between the clocks. The electronic devices in the distributed system may communicate over a virtual network such as a virtual local area network (VLAN) or another type of virtual network. In some cases, the electronic devices support sending timing messages over just a single virtual network. However, in examples where electronic devices support communications over multiple virtual networks, timing messages may be transmitted on just a single virtual network. As a result, even though time synchronization may be performed based on timing messages over the single virtual network, time synchronization may not be possible over other virtual networks. Different virtual networks may be associated with different delays between clocks, so that an offset between clocks computed for one virtual network may not be applicable to other virtual networks.

In accordance with some implementations of the present disclosure, time clocks in electronic devices support the transmission of timing messages over different virtual networks to perform time synchronizations over the different virtual networks. In some examples, a first electronic device includes an interface to communicate over multiple virtual networks, such as VLANs or other types of virtual networks. An example of the interface includes a trunk port that supports communications of the multiple virtual networks. The first electronic device includes a memory storing a mapping between virtual stream identifiers (IDs) and respective interface-virtual network combinations. The virtual stream IDs identify respective communication streams over corresponding virtual networks. Each interface-virtual network combination includes an ID of the interface (e.g., a port ID) and an ID of a virtual network, such as a VLAN ID and so forth. The first electronic device includes a first time clock to provide time information. As part of a time synchronization process over a virtual network, the first time clock performs a lookup of the mapping using a first virtual stream ID to retrieve an ID of the virtual network, where the first virtual stream ID identifies a communication stream over the virtual network. The first time clock adds the ID of the virtual network to a timing message, and the first time clock sends, over the virtual network, the timing message to a second electronic device that includes a second time clock to which the first time clock of the first electronic device is to be synchronized over the virtual network according to the time synchronization process.

By using techniques or mechanisms according to some implementations of the present disclosure, time synchronization processes (such as PTP processes) can be performed separately for respective VLANs so that time clocks of electronic devices coupled over different VLANs can be synchronized with one another. In some examples, a VLAN can be represented by a logical layer 3 virtual interface in an electronic device. An example of a logical layer 3 virtual interface is a switch virtual interface (SVI), which presents a layer 3 endpoint over a VLAN. In such an example, if SVI is enabled in a switch, then a time synchronization process (such as a PTP process) can be performed using an SVI. Multiple SVIs may be implemented on one or more ports of a switch, where these SVIs represent different VLANs. Separate time synchronization processes can be performed over the separate SVIs. More generally, in examples where multiple logical layer 3 virtual interfaces are implemented on one or more physical interfaces of an electronic device, separate time synchronization processes can be performed through the logical layer 3 virtual interfaces that represent respective different virtual networks.

Examples of electronic devices with time clocks include any or some combination of the following: network devices (e.g., switches, routers, gateways, etc.), computers (e.g., desktop computers, notebook computers, tablet computers, server computers, etc.), smartphones, vehicles, game appliances, storage systems, Internet-of-Things (IoT) devices, or other types of electronic devices.

An ID is a value (e.g., a numerical value, an alphanumeric value, or any other type of value) that is used to identify a specific entity. Thus, a VLAN ID is used to identify a VLAN. Different VLANs may be assigned different VLAN IDs.

A “time clock” in an electronic device refers to hardware circuitry (or a combination of hardware circuitry and machine-readable instructions) that generates a current time. The time clock is capable of performing a time synchronization process (such as according to the PTP) with other time clocks.

A time synchronization process allows time clocks in different electronic devices to compute a time offset (or more simply, an “offset”) between the time clocks, so that a time provided by one of the time clocks can be adjusted by the offset to synchronize the time clocks.

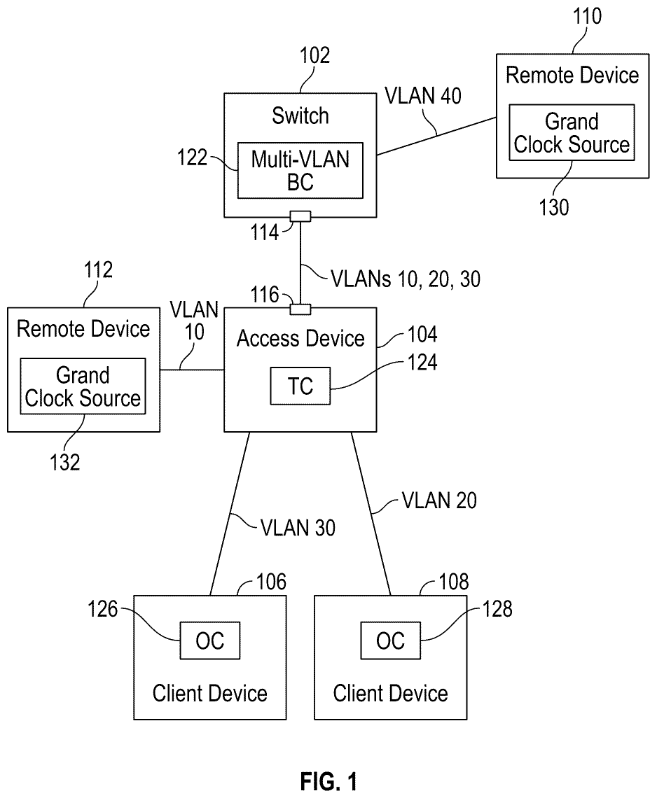

FIG. 1 is a block diagram of an example arrangement that includes various electronic devices with time clocks. The electronic devices include a switch 102, an access device 104, client devices 106 and 108, and remote devices 110 and 112. In further examples, a network can include different quantities of switches, access devices, remote devices, and client devices. Also, although specific types of electronic devices are shown in FIG. 1, it is noted that in other examples, other electronic devices can include some combination of the time clocks shown in FIG. 1.

A “switch” is a network device that forwards data packets along network paths of a network. Examples of switches can include a layer 2 switch, a layer 3 router, or any other type of network device that is able to forward data packets based on network address information contained in the data packets.

An “access device” can refer to an access point (AP) of a wireless local area network (WLAN), a base station of a cellular network, or any other type of device to which client devices are connected, either over a wireless or wired connection, to obtain access to a network.

A “client device” can refer to any electronic device that accesses a remote service in a system, such as services in a cloud, on a server, in a data center, or any other computing environment. A “remote device” may include any electronic device that is part of a cloud, an arrangement of one or more servers, a data center, or any other computing environment.

The remote device 110 includes a grand clock source 130, and the remote device 112 includes a grand clock source 132. A “grand clock source” is a clock source with a higher clock quality (than other clocks in the arrangement of FIG. 1) and which may have direct access to a reference clock. The reference clock may include a high frequency oscillator, a Global Positioning System (GPS) clock, or any other time reference. According to PTP, the grand clock source is a grand master clock.

The switch 102 includes a multi-VLAN boundary clock (BC) 122. A “boundary clock” or “BC” refers to a time clock in an electronic device that synchronizes to a clock source that is upstream of the BC and acts as a clock source to a clock sink downstream of the BC. A multi-VLAN time clock, such as the multi-VLAN BC 122, is a time clock that supports time synchronization processes over multiple VLANs. If other types of virtual networks are employed, a multi-virtual network time clock is a time clock that supports time synchronization processes over multiple virtual networks.

An “upstream time clock” refers to a time clock that is a clock source (that provides a time reference) for a time clock of another electronic device. A “downstream time clock” refers to a time clock that is a clock sink that uses a time clock of another electronic device as a reference. According to PTP, the clock source is a master clock, and the clock sink is a slave clock.

The access device 104 includes a transparent clock (TC) 124. A “transparent clock” or “TC” is an intermediate time clock that can calculate time delays over network links, but the TC does not synchronize to other time clocks.

The client device 106 includes an ordinary clock (OC) 126, and the client device 108 includes an OC 128. An “ordinary clock” or “OC” is a time clock that is not connected to any downstream time clock (i.e., the OC does not act as a clock source for another time clock).

In other examples, the client devices 106 and 108 can be connected directly to the switch 102, in which case access device 104 including the TC 124 can be omitted.

In the example of FIG. 1, electronic devices communicate over various different VLANs. Although reference is made to VLANs in some examples described herein, it is noted that techniques or mechanisms according to some implementations of the present disclosure can be applied with other types of virtual networks.

The switch 102 includes a trunk port 114 that is able to communicate over multiple VLANs 10, 20, and 30 with a trunk port 116 of the access device 104. A trunk port is a physical port that supports multiple VLANs. In other examples, the switch 102 and the access device 104 can include other types of physical interfaces over which communications of multiple virtual networks can occur.

The remote device 110 is connected to the switch 102 over VLAN 40 (a VLAN with a VLAN ID of 40), and the remote device 112 is connected to the access device 104 over VLAN 10. The client device 106 is connected to the access device 104 over VLAN 30, and the client device 108 is connected to the access device 104 over VLAN 20. Although specific VLAN IDs are depicted in FIG. 1, in other examples, VLANs may be assigned different VLAN IDs.

In the example arrangement of FIG. 1, for computing end-to-end delays, timing messages between the grand clock source 130 and the BC 122 are exchanged over VLAN 40, and timing messages between the grand clock source 132 and the BC 122 is over the VLAN 10. For computing end-to-end delays, timing messages between the OC 126 and the BC 122 are exchanged over VLAN 30, and timing messages between the OC 128 and the BC 122 are exchanged over that VLAN 20. An end-to-end delay determined between a clock source and a clock sink can be used to compute an offset between the clock source and the clock sink.

Additionally, peer-to-peer timing messages can be exchanged between peers to determine a delay over a network link, such as a layer 2 link (e.g., an Ethernet link). A peer-to-peer exchange of timing messages allows for the computation of a delay over a network hop between time clocks, such as between the BC 122 and the TC 124, between the TC 124 and the OC 126, and between the TC 124 and the OC 128. The peer-to-peer delay can be used to correct timing information in certain timing messages exchanged over a network link.

When multiple VLANs are enabled on a port, such as the trunk port 114 of the switch 102, separate time synchronization processes may be performed over the multiple VLANs. Each time synchronization process over a specific VLAN includes a corresponding different exchange of timing messages, such as PTP messages.

More specifically, in the example of FIG. 1, the BC 122 can perform an end-to-end exchange of timing messages with the grand clock source 130 over VLAN 40, an end-to-end exchange of timing messages over VLAN 10 with the grand clock source 132, an end-to-end exchange of timing messages over VLAN 20 with the OC 128, and an end-to-end exchange of timing messages over VLAN 30 with the OC 126.

In this way, the BC 122 is able to compute the VLAN-specific end-to-end delays over different VLANs 10, 20, 30, and 40 with respective different time clocks. The BC 122 can use the grand clock source 130 as a clock source over VLAN 40, and the BC 122 can use the grand clock source 132 as a clock source over VLAN 10. The OC 126 uses the BC 122 as a clock source over VLAN 30, and the OC 128 uses the BC 122 as a clock source over VLAN 20.

If the grand clock source 130 available over VLAN 40 is to become unavailable, the BC 122 can switch to using the grand clock source 132 available over VLAN 10 as a clock source. Similarly, if the grand clock source 132 available over VLAN 10 is to become unavailable, the BC 122 can switch to using the grand clock source 130 available over VLAN 40 as a clock source. In further examples, when both the grand clock sources 130 and 132 are available, the BC 122 can select one of the grand clock sources 130 and 132 to use as a clock source, even though the grand clock sources 130 and 132 are on separate VLANs. For example, the BC 122 can select one of the grand clock sources 130 and 132 according to a best clock source algorithm, which according to PTP is referred to as a Best Master Clock Algorithm (BMCA). The selection of which of the grand clock sources 130 and 132 to use can be based on quality information of the grand clock sources 130 and 132, which can be provided in announce messages (discussed further below) transmitted by the grand clock sources 130 and 132.

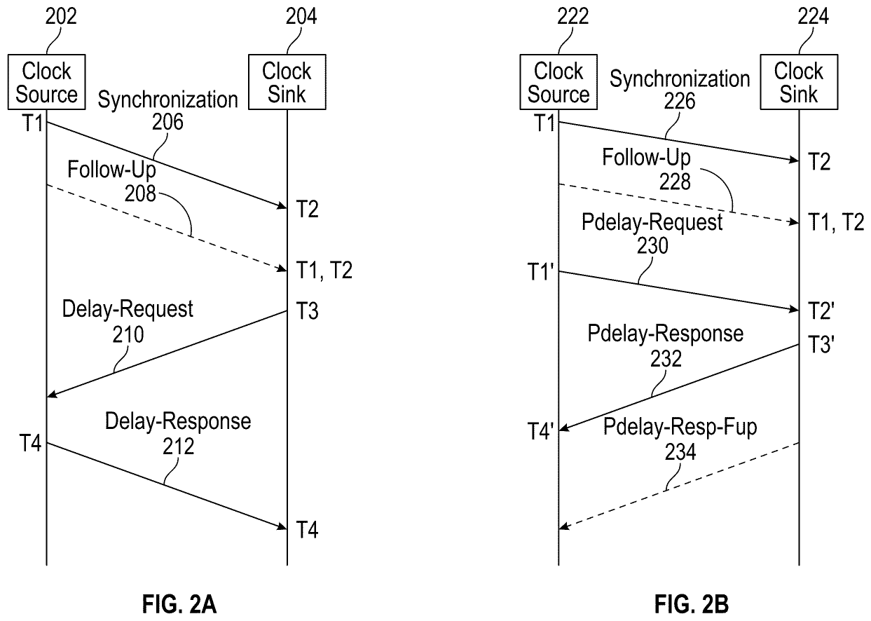

FIG. 2A is a timing diagram showing an exchange of PTP timing messages between a clock source 202 and a clock sink 204 that employs an end-to-and delay mechanism. FIG. 2B is a timing diagram showing an exchange of timing messages between a clock source 222 and a clock sink 224 that employs a peer-to-peer delay mechanism. The IEEE 1588 Specification describes the timing messages and how the timing messages are handled.

In FIG. 2A, the clock source 202 can be the BC 122 of FIG. 1, and the clock sink 204 can be the OC 126 or 128 of FIG. 1. Alternatively, the clock source 202 can be the grand clock source 130 or 132, and the clock sink 204 can be the BC 122. The exchange of PTP timing messages as shown in FIG. 2A can be performed for each VLAN; in other words, a first exchange of PTP timing messages is performed over a first VLAN, a second exchange of PTP timing messages is performed over a second VLAN, and so forth.

The timing messages of FIG. 2A include a synchronization message 206 (e.g., a PTP Sync message) sent from the clock source 202 to the clock sink 204. The synchronization message 206 is sent by the clock source 202 to the clock sink 204 to initiate a time synchronization process. The clock source 202 can record an egress timestamp (T1), which is the time at which the synchronization message 206 was sent. If the clock source 202 is a one-step clock, then T1 can be carried in the synchronization message 206. If the clock source 202 is a two-step clock, then T1 is carried in a follow-up message 208 (PTP Follow-Up message) sent after the synchronization message 206. Upon receiving the synchronization message 206 (or if applicable the follow-up message), the clock sink 204 records an ingress timestamp (T2) at which the clock sink 204 received the synchronization message 206. The clock sink 204 also records the egress timestamp (T1) from the clock source 202, where T1 may be included in the synchronization message 206 or the follow-up message 208.

The clock sink 204 sends a delay-request message 210 (e.g., PTP DelayReq message) to the clock source 202. The clock sink 204 can record an egress timestamp (T3) at which the delay-request message 210 was sent from the clock sink 204. The clock source 202 receives the delay-request message 210 and records an ingress timestamp (T4) at which the delay-request message 210 was received at the clock source 202. The clock source 202 then sends a delay-response message 212 (e.g., PTP DelayResp) to the clock sink 204. The delay-response message 212 contains the ingress timestamp (T4) of the delay-request message 210.

Using the timestamps T1, T2, T3, and T4, the clock sink 204 is able to determine a time offset of the clock sink 204 relative to the clock source 202, such as using computations according to the PTP. The time offset refers to a difference in time between the clock source and the clock sink based on various delays between the clock source and the clock sink. This time offset is used to adjust the clock sink's time so that the clock sink 204 is time synchronized with the clock source 202.

The following discusses how end-to-end exchanges of timing messages according to FIG. 2A over different VLANs are supported. A discussion of FIG. 2B is provided further below.

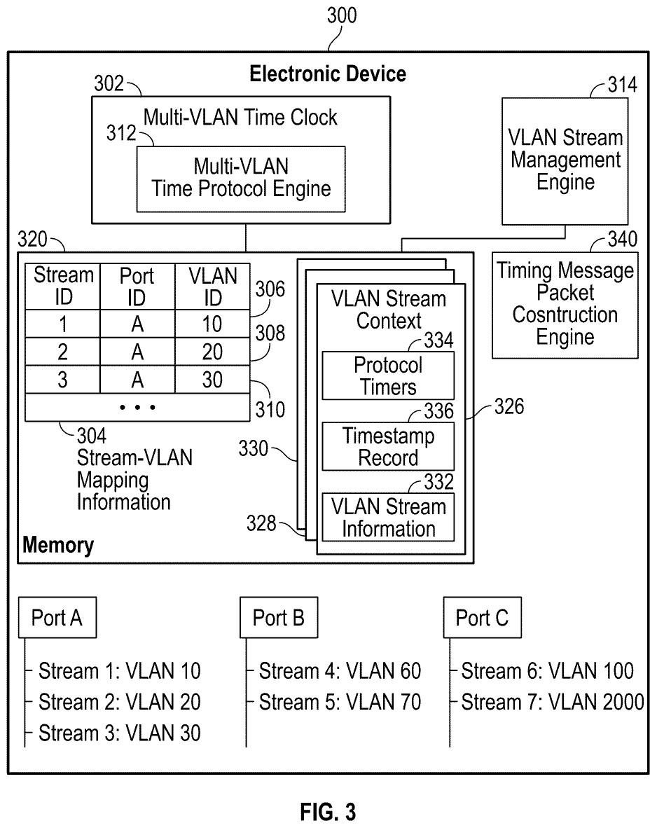

As shown in FIG. 3, to support exchanges of timing messages over different VLANs, a multi-VLAN time clock 302 in an electronic device 300 maintains stream-VLAN mapping information 304 including entries 306, 308, and 310 that correlate stream IDs to combinations of port IDs and VLAN IDs. The stream-VLAN mapping information 304 is stored in a memory 320 of the electronic device 300.

A port ID identifies a port (e.g., port A, port B, and port C) of the electronic device 300 in which the time clock 302 is included, and a VLAN ID identifies a VLAN. In the example of FIG. 3, it is assumed that each of ports A, B, and C supports communications over multiple VLANs. In other examples, a port may not be a trunk port and thus can be used to communicate over a single VLAN.

A stream ID identifies a VLAN stream over which timing messages are exchanged over a respective VLAN. A VLAN stream represents a virtual port provided on a physical port. Multiple virtual ports can be provided on the physical port to support communications over respective VLANs (or more generally, respective virtual networks).

In the example of FIG. 3, VLAN streams with stream IDs 1, 2, and 3 are defined on port A, VLAN streams with stream IDs 4 and 5 are defined on port B, and VLAN streams with stream IDs 6 and 7 are defined on port C. Defining a VLAN stream on a physical port refers to creating a virtual port that uses the physical port for communications. In other examples, each port A, B, or C can support a different quantity of VLAN streams than depicted in FIG. 3.

The stream-VLAN mapping information 304 can be in the form of a table or another type of data structure. The entry 306 correlates stream ID 1 to the combination of port A and VLAN 10. The entry 308 correlates stream ID 2 to the combination of port A and VLAN 20. The entry 310 correlates stream ID 3 to the combination of port A and VLAN 30. The stream-VLAN mapping information 304 includes additional entries (not shown) that correlate stream IDs 4, 5, 6, and 7 to respective combinations of port IDs and VLAN IDs.

The time clock 302 includes a multi-VLAN time protocol engine 312 that supports exchanges of timing messages over respective VLAN streams. The electronic device 300 further includes a VLAN stream management engine 314 that manages the creation or removal of VLAN streams. Although shown as two separate engines, in other examples, the time protocol engine 312 and the VLAN stream management engine 314 can be integrated into one engine. The electronic device 300 further includes a timing message packet construction engine 340 to construct a packet containing a timing message that is to be transmitted from the electronic device 300. The timing message packet construction engine 340 may be part of or separate from the time clock 302.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

When a VLAN stream is defined, a respective VLAN stream context is created and stored in the memory 320. For example, in FIG. 3, the VLAN stream management engine 314 creates a VLAN stream context 326 for stream ID 1, a VLAN stream context 328 for stream ID 2, a VLAN stream context 330 for stream ID 3, and other VLAN stream contexts for other VLAN streams. A VLAN stream context includes various information (discussed further below) relating to a VLAN stream.

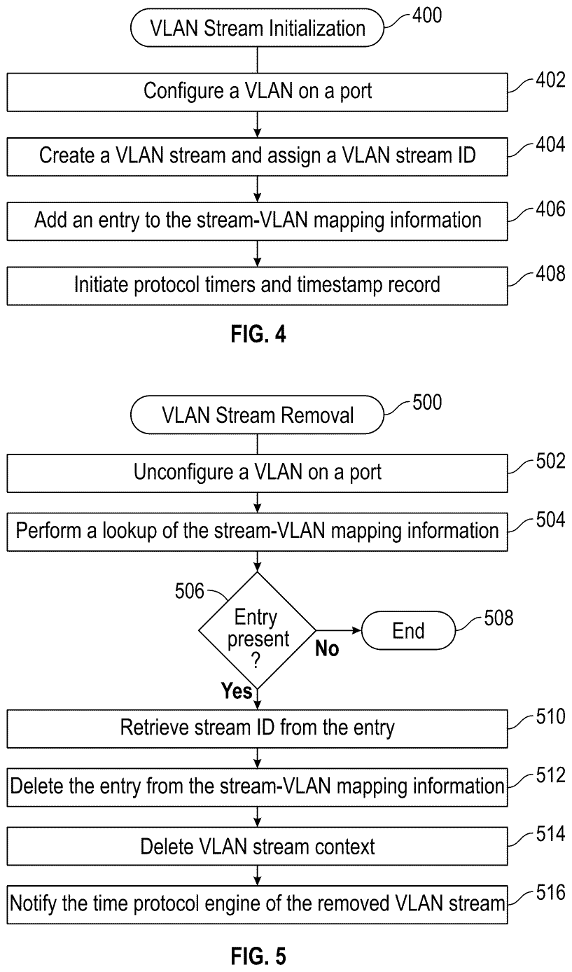

FIG. 4 is a flow diagram of a VLAN stream initialization process 400 in the electronic device 300 of FIG. 3, in accordance with some examples of the present disclosure. The electronic device 300 configures (at 402) a VLAN on a specific port (e.g., configure VLAN 10 on port A), such as in response to a request from a user (e.g., a network administrator), a program, or a machine. The VLAN configuration request can specify a VLAN ID of the VLAN to be configured at the electronic device 300, a physical port on which the VLAN is to be defined, and other information associated with the VLAN.

In response to the configuration of VLAN 10 on port A, the VLAN stream management engine 314 creates (at 404) a VLAN stream and assigns a stream ID (e.g., 1) to the created VLAN stream. As part of creating the VLAN stream at the electronic device 300, the VLAN stream management engine 314 generates the VLAN stream context 326. The VLAN stream management engine 314 stores the VLAN stream context 326 in the memory 320 of the electronic device 300.

In the example shown in FIG. 3, the VLAN stream context 326 includes VLAN stream information 332, which can include the stream ID of the VLAN stream that is created. The VLAN stream context 326 also includes protocol timers 334 and a timestamp record 336.

The VLAN stream management engine 314 adds (at 406) the entry 306 to the stream-VLAN mapping information 304. The added entry correlates the assigned stream ID 1 to the combination of a port ID (A) and a VLAN ID (10) of the VLAN that was configured.

In response to the creation of the VLAN stream, the time protocol engine 312 initiates (at 408) the protocol timers 334 and the timestamp record 336 for the created VLAN stream. A protocol timer is used to determine when a specific timing message is to be transmitted or received. Initiating the protocol timers 334 can refer to setting the protocol timers 334 to initial values and starting the protocol timers. Initiating the timestamp record 336 can refer to creating the timestamp record 336 to populate with timestamps derived in a time synchronization process.

As examples, the protocol timers 334 can include announce timers and synchronization timers. Each protocol timer is to count a respective time interval, after which the protocol timer expires (times out). Upon expiration of the protocol timer, the time protocol engine 312 takes a corresponding action. The announce timers include a transmit announce timer and a receive announce timer. Upon expiration of the transmit announce timer, the time protocol engine 312 sends an announce message. Upon expiration of the receive announce timer, the time protocol engine 312 receives and processes an announce message sent by another time clock. Prior to expiration of the receive announce timer, the time protocol engine 312 disregards any incoming announce messages. An announce message contains quality attributes regarding a time clock that sent the announce message. For example, the quality attributes include a class, a priority, and/or a quality of the time clock. Announce messages exchanged between a first time clock and a second time clock can be used by the first and second time clocks to determine (based on a comparison of the quality attributes) which of the first and second time clocks is the clock source and which of the first and second time clocks is the clock sink. The selection of the clock source and clock sink can be according to a best clock source algorithm, which according to PTP is referred to as a Best Master Clock Algorithm (BMCA).

The synchronization timers include a transmit synchronization timer and a receive synchronization timer. Upon expiration of the transmit synchronization timer, the time protocol engine 312 sends a synchronization message (e.g., 206 in FIG. 2). Upon expiration of the receive synchronization timer, the time protocol engine 312 receives and processes a synchronization message (e.g., 206 in FIG. 2) sent by another time clock. Prior to expiration of the synchronization timer, the time protocol engine 312 disregards any incoming synchronization messages.

The timestamp record 336 stores timestamps (e.g., T1, T2, T3, and T4 in FIG. 2) derived based on an exchange of timing messages over VLAN 10. A record can include a database, a table, or any other type of data structure.

After completion of the VLAN stream initialization process 400, the multi-VLAN time protocol engine 312 is able to perform a time synchronization process using the created VLAN stream (having stream ID 1).

FIG. 5 is a flow diagram of a VLAN stream removal process 400 in the electronic device 300 of FIG. 3, in accordance with some examples of the present disclosure. The electronic device 300 unconfigures (at 502) a VLAN on a specific port (e.g., unconfigure VLAN 60 on port B), such as in response to a VLAN unconfigure request from a user (e.g., a network administrator), a program, or a machine. The VLAN unconfigure request can specify a VLAN ID of the VLAN to be unconfigured at the electronic device 300, and a physical port on which the VLAN is defined. Unconfiguring a VLAN at the electronic device 300 refers to removing the VLAN from use by the electronic device 300. This removal may occur due to a teardown of the VLAN. This removal may also occur if use of the VLAN by the electronic device 300 is to be disabled.

In response to unconfiguring VLAN 60 on port B, the VLAN stream management engine 314 performs a lookup (at 504) of the stream-VLAN mapping information 304 to determine (at 506) if an entry for the unconfigured VLAN exists. The lookup is based on a combination of VLAN 60 and port B.

If the VLAN stream management engine 314 determines (at 506) that an entry does not exist in the stream-VLAN mapping information 304 for VLAN 60 on port B, no further action is taken and the process 500 ends (at 508).

However, if the VLAN stream management engine 314 determines (at 506) that the entry for VLAN 60 on port B exists in the stream-VLAN mapping information 304, the time protocol engine 312 retrieves (at 510) the stream ID (4) from the entry. The VLAN stream management engine 314 deletes (at 512) the entry from the stream-VLAN mapping information 304. Using the retrieved stream ID, the stream-VLAN mapping information 304 also deletes (at 514) the VLAN stream context for the VLAN stream corresponding to VLAN 60 on port B, which effectively removes the VLAN stream. The VLAN stream management engine 314 also notifies (at 516) the time protocol engine 312 of the VLAN stream that is being removed, which causes the time protocol engine 312 to stop any in-progress time synchronization process using the VLAN stream.

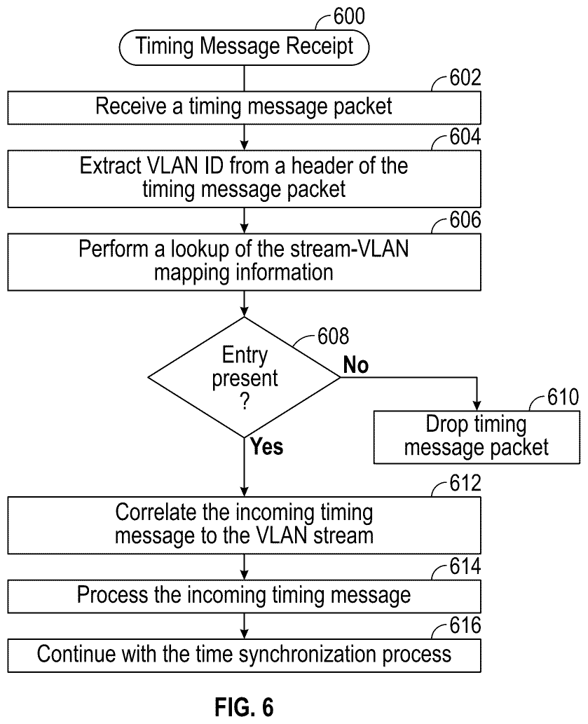

FIG. 6 is a timing message receipt process 600, which can be performed by the electronic device 300 of FIG. 3, for example. An incoming timing message is contained in a data packet sent from a clock source to a clock sink. In the example of FIG. 6, the clock sink is the time clock 302 in the electronic device 300. The data packet has a layer 2 header (e.g., an Ethernet header) containing a VLAN ID.

The electronic device 300 receives (at 602) a packet containing the incoming timing message (“timing message packet”) on a specific port (e.g., port A). The electronic device 300 parses the layer 2 header of the timing message packet and extracts (at 604) the VLAN ID from the layer 2 header. In the example of FIG. 6, it is assumed that the extracted VLAN ID is VLAN 20. The extracted VLAN ID is provided to the time protocol engine 312.

The time protocol engine 312 performs (at 606) a lookup of the stream-VLAN mapping information 304 to identify an entry that corresponds to port A and VLAN 20. The time protocol engine 312 determines (at 608) whether an entry corresponding to VLAN 20 and port A is found. If not, the time protocol engine 312 drops (at 610) the timing message packet.

However, if the entry corresponding to VLAN 20 and port A is present in the stream-VLAN mapping information 304, the time protocol engine 312 correlates (at 612) the incoming timing message to the VLAN stream referenced by stream ID 2. The incoming timing message may be a synchronization message (e.g., 206 in FIG. 2A). The time protocol engine 312 processes (at 614) the incoming timing message, which can include deriving a timestamp based on the incoming timing message. The time protocol engine 312 adds the timestamp to a timestamp record for the VLAN stream referenced by stream ID 2. The time protocol engine 312 continues (at 616) with the time synchronization process and updates the timestamp record for the VLAN stream with additional timestamps derived in the time synchronization process.

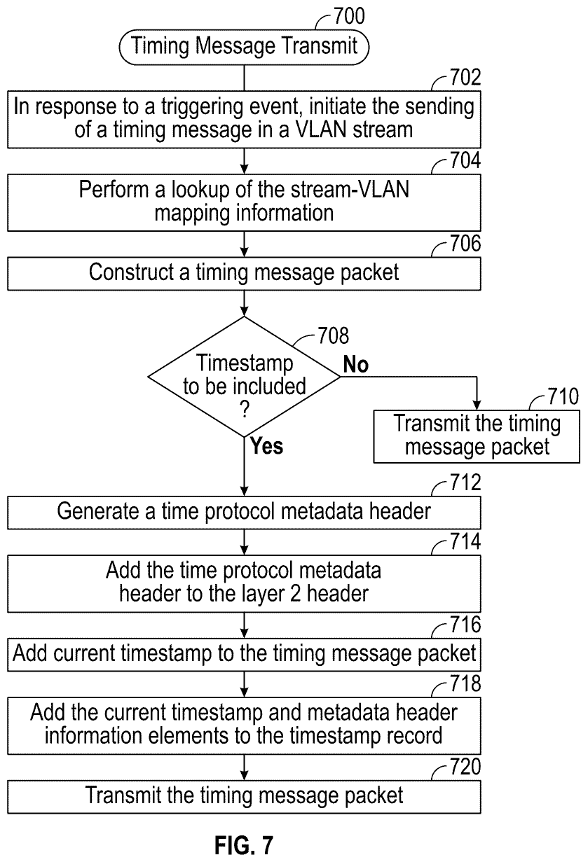

FIG. 7 is a flow diagram of a timing message transmit process 700, which can be performed by the electronic device 300 of FIG. 3, for example. In response to a triggering event for a time synchronization process over a VLAN stream identified by a stream ID, the time protocol engine 312 initiates (at 702) the sending of a timing message in the VLAN stream. The triggering event may include an expiration of a transmit synchronization timer, for example, which causes the time protocol engine 312 to transmit a synchronization message. For example, the VLAN stream may be identified by stream ID 1, which corresponds to VLAN 10 on port A. The transmit synchronization timer that expired is one of the protocol timers 334 of the VLAN stream context 326 for stream ID 1. In another example, the triggering event may include a receipt of a timing message from another time clock at the electronic device 300. For example, in response to receipt of a synchronization message, the time protocol engine 312 can send a delay-request message (e.g., 210 in FIG. 2A). As another example, in response to a receipt of a delay-request message, the time protocol engine 312 can send a delay-response message (e.g., 212 in FIG. 2A).

The timing message packet construction engine 340 in the electronic device 300 performs a lookup (at 704) of the stream-VLAN mapping information 304 based on stream ID 1 to identify the entry corresponding to stream ID 1. The timing message packet construction engine 340 constructs (at 706) a timing message packet by adding the VLAN ID in the identified entry to the layer 2 header of the timing message packet.

Certain timing messages contain egress timestamps. For example, the synchronization message (e.g., 206 in FIG. 2A) or the follow-up message (e.g., 208 in FIG. 2A) may contain timestamp T1, and the delay-request message (e.g., 210 in FIG. 2A) may contain timestamp T3. In some examples of the present disclosure, the timestamp included in a timing message packet is mapped to the following combination of information elements: {stream ID, sequence ID, message type, and egress port}. The sequence ID is a monotonically increasing ID that identifies a time synchronization process. When a new time synchronization process is started by a clock source, the sequence ID is incremented. The message type indicates the type of the timing message (e.g., synchronization message, follow-up message, etc.). The egress port identifies the physical port through which the timing message packet is transmitted.

The timing message packet construction engine 340 determines (at 708) whether an egress timestamp is to be included in the timing message. If not, the electronic device 300 transmits (at 710) the timing message packet to a destination electronic device containing a time clock with which the time clock 302 of the electronic device 300 is to be synchronized.

However, if an egress timestamp is included in the timing message, the timing message packet construction engine 340 generates (at 712) a time protocol metadata header containing the following information elements: {stream ID, sequence ID, message type, and egress port}. The timing message packet construction engine 340 adds (at 714) the time protocol metadata header to the layer 2 header of the timing message packet. The addition of the time protocol metadata header to the timing message packet is to allow hardware, such as a programmable integrated circuit device or another type of hardware in the electronic device, to fetch an egress timestamp from a hardware time source and return the egress timestamp to the timing message packet construction engine 340 as a key-value pair. In such an example, the key includes {stream ID, sequence ID, message type, egress port}, and the value is the egress timestamp.

The timing message packet construction engine 340 obtains a current timestamp (which is the egress timestamp returned by the hardware), and adds (at 716) the current timestamp to the payload of the timing message packet. Note that when the timing message packet is actually transmitted, the time protocol metadata is stripped from the timing message packet before transmission to a recipient. However, the sequence ID is included in the timing message packet. More generally, the timing message packet construction engine 340 provides a key to the electronic device's hardware, which returns an egress timestamp with the key for the timing message packet construction engine 340 to add to the timing message packet.

The timing message packet construction engine 340 also adds (at 718) the above information elements along with the current timestamp to the timestamp record 336. In this way, timestamps in a timestamp record for each VLAN stream can be correlated to stream IDs and sequence IDs.

The electronic device then transmits (at 720) the timing message packet with the timestamp (along with the sequence ID) to the destination electronic device. By including the sequence ID in the timing message packet, the recipient of the timing message packet is also able to correlate the timestamp in the timing message packet to the sequence ID. In an example, for a given VLAN stream on a port, a clock source sends a synchronization message (e.g., 206 in FIG. 2A) at time T1 with sequence ID 1. If a two-step clock is used, a follow-up message (e.g., 208 in FIG. 2A) can also be sent with sequence ID 1. A clock sink receives the synchronization message (and follow-up message if appropriate) at time T2. The clock sink sends a delay-request message (e.g., 210 in FIG. 2A) at time T3 for sequence ID 1 to the clock source. The clock source then sends a delay-response message (e.g., 212 in FIG. 2A) at time T4 for sequence ID 1.

Although end-to-end delays are computed on a per-VLAN basis, peer-to-peer delays may be derived for a network link, not for a VLAN. FIG. 2B is a timing diagram showing exchanges of timing messages between a clock source 222 and a clock sink 224 for determining a peer-to-peer delay. A clock source 222 sends a synchronization message 226 to a clock sink 224 (and possibly a follow-up message 228 if the clock source is a two-step clock source). The clock source 222 may be the BC 122 of FIG. 1, and the clock sink 224 may be the TC 124. Alternatively, the clock source 222 may be the TC 124, and the clock sink 224 may be the OC 126 or 128.

FIG. 2B further shows a Pdelay-request message 230 sent from the clock source 222 to the clock sink 224, which responds with a Pdelay-response message 232 from the clock sink 224 to the clock source 222 (and possibly a Pdelay-resp-fup message 234 if the clock sink 224 is a two-step clock). Details of a Pdelay-request message, a Pdelay-response message, and a Pdelay-resp-fup message are discussed in the PTP IEEE 1588 Specification. Based on the exchange of the timing messages, a peer-to-peer delay between the clock source 222 and the clock sink 224 is computed.

In case there are multiple VLANs between the clock source 222 and the clock sink 224, one of the VLANs is used to carry out the peer-to-peer delay determination process of FIG. 2B. The selected VLAN may be specified in configuration information provided by a user, a program, or a machine. The timing messages of FIG. 2B are exchanged in the selected VLAN. Note that the peer-to-peer delay is derived for the network link, not any VLAN. In alternative examples, peer-to-peer delay may be determined between time clocks coupled over multiple network links (multiple hops). In such examples, peer-to-peer delays may be separately determined over respective VLANs or over just one VLAN, depending on which configuration option is specified. A first configuration option may specify that a peer-to-peer delay is to be derived over just one VLAN in a multi-VLAN environment. A second configuration option may specify that individual peer-to-peer delays are determined over separate VLANs.

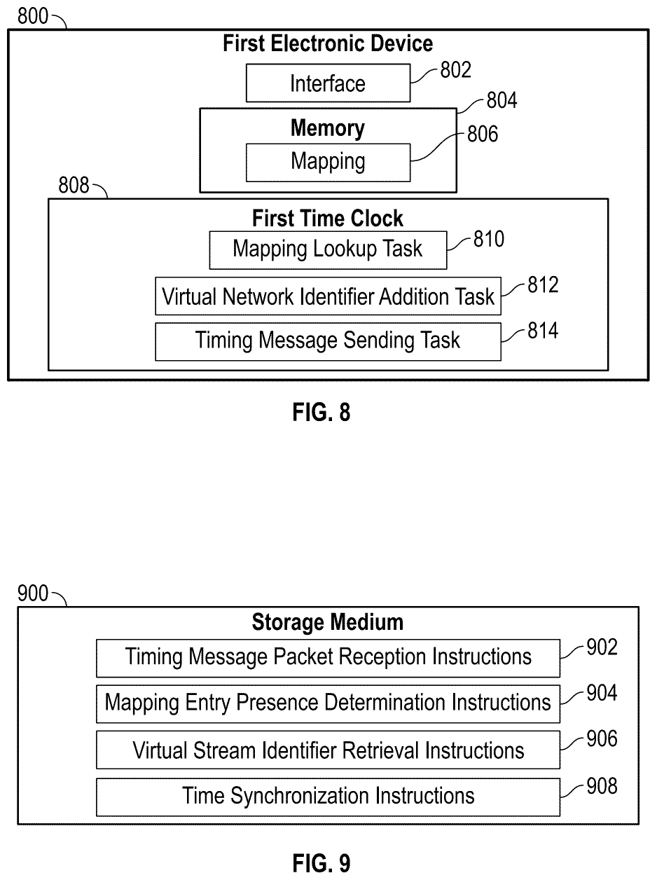

FIG. 8 is a block diagram of a first electronic device 800 according to some examples. The first electronic device 800 may be a switch or another type of electronic device. The first electronic device 800 includes an interface 802 to communicate over multiple virtual networks, such as VLANs. The interface 802 may be a trunk port, for example.

The first electronic device 800 includes a memory 804 that stores a mapping 806 between virtual stream identifiers (e.g., stream IDs) and respective interface-virtual network combinations. A virtual stream identifier identifies a communication stream (e.g., a VLAN stream) over a virtual network. An interface-virtual network combination includes an identifier of the interface 802 (e.g., a port ID) and an identifier of a virtual network (e.g., a VLAN ID). An example of the mapping 806 is the stream-VLAN mapping information 304 of FIG. 3.

The first electronic device 800 includes a first time clock 808 to provide time information. The first time clock 808 performs various tasks, which may be performed by hardware processing circuitry of the first time clock 808 or machine-readable instructions executed by the first time clock 808.

The tasks of the first time clock 808 include a mapping lookup task 810 to, as part of a first time synchronization process over a first virtual network, perform a lookup of the mapping 806 using a first virtual stream identifier to retrieve an identifier of the first virtual network, the first virtual stream identifier identifying a communication stream over the first virtual network. For example, the mapping lookup task 810 can retrieve a VLAN ID based on a stream ID.

The tasks of the first time clock 808 include a virtual network identifier addition task 812 to add the identifier of the first virtual network to a first timing message. For example, the identifier of the first virtual network (e.g., a VLAN ID) can be added to a layer 2 header of a packet containing the first timing message.

The tasks of the first time clock 808 include a timing message sending task 814 to send, over the first virtual network, the first timing message to a second electronic device that includes a second time clock to which the first time clock of the first electronic device is to be synchronized over the first virtual network according to the first time synchronization process. The first time synchronization process includes an exchange of timing messages to derive timestamps for computing an offset between the first and second time clocks.

In some examples, the first time clock 808 receives, over the first virtual network, a second timing message of the first time synchronization process from the second time clock, the second timing message containing the identifier of the first virtual network.

In some examples, the first time clock 808 performs a lookup of the mapping 806 using the identifier of the first virtual network contained in the second timing message to retrieve the first virtual stream identifier correlated by the mapping to the identifier of the first virtual network. The first time clock 808 associates the second timing message with the communication stream over the first virtual network. Associating the second timing message with the communication stream over the first virtual network allows the first time clock 808 to continue with the first time synchronization process to develop further timestamps and to communicate further timing messages.

In some examples, the first time clock 808 adds a timestamp associated with the second timing message to a timestamp record associated with the communication stream over the first virtual network. An example of the timestamp record is the timestamp record 336 of FIG. 3. The first time clock 808 uses timestamps in the timestamp record to synchronize the first time clock 808 and the second time clock over the first virtual network.

In some examples, the first time clock 808 sends, over a second virtual network, a second timing message of a second time synchronization process to a target electronic device that includes a time clock to which the first time clock of the first electronic device is to be synchronized over the second virtual network according to the second time synchronization process. The second virtual network is different from the first virtual network.

In some examples, the first time clock 808 receives a configuration of the first virtual network on the interface 802. For example, the first time clock 808 receives a request to configure the first virtual network on the interface 802, such as from a user, a program, or a machine. Responsive to the configuration of the first virtual network on the interface, the first time clock 808 creates the first virtual stream identifier and adds an entry to the mapping 806. The entry added contains the first virtual stream identifier correlated to a combination of the identifier of the interface 802 and an identifier of the first virtual network.

In some examples, the first time clock 808 initializes protocol timers for the first time synchronization process and creates a timestamp record to store timestamps associated with the first time synchronization process.

In some examples, the first electronic device 800 includes a protocol timer associated with the first time synchronization process. Responsive to an expiration of the protocol timer, the first time clock 808 sends a timing message of the first time synchronization process (e.g., such as a synchronization message).

In some examples, the first time clock 808 determines whether a timestamp is to be included in the first timing message. Based on determining that the timestamp is to be included in the first timing message, the first time clock 808 adds metadata to the first timing message, the metadata including the first virtual stream identifier to be correlated to the timestamp.

In some examples, the metadata further includes a message type of the first timing message and the identifier of the interface from which the first timing message egresses.

In some examples, the metadata further includes a sequence identifier of the first timing message. The first time clock 808 adds the timestamp and the sequence identifier to a timestamp record for the communication stream over the first virtual network.

In some examples the first time clock 808 computes an offset for an end-to-end delay between the first time clock and the second time clock using the timestamp.

In some examples, for deriving a link-level peer-to-peer delay between the first time clock and a next hop of in a network path, the first time clock 808 sends a further timing message to compute the link-level peer-to-peer delay.

In some examples, the first time clock 808 receives configuration information indicating a selected virtual network of the multiple virtual networks to use for determining the link-level peer-to-peer delay. The further timing message is sent over the selected virtual network.

FIG. 9 is a block diagram of a non-transitory machine-readable or computer-readable storage medium 900 storing machine-readable instructions that upon execution cause a first electronic device including a first time clock to perform various tasks.

The machine-readable instructions include timing message packet reception instructions 902 to receive, at the first electronic device from a second electronic device including a second time clock to be synchronized with the first time clock, a packet including a timing message. The packet contains a virtual network identifier of a virtual network (e.g., a VLAN ID), and the packet is received at an interface identified by an interface identifier.

The machine-readable instructions include mapping entry presence determination instructions 904 to determine whether a mapping correlating virtual stream identifiers and interface-virtual network combinations contains an entry for a combination of the virtual network identifier and the interface identifier. An example of the mapping is the stream-VLAN mapping information 304 of FIG. 3.

The machine-readable instructions include virtual stream identifier retrieval instructions 906 to, based on determining that the entry is present in the mapping, retrieve a virtual stream identifier from the entry that correlates the virtual stream identifier to the combination of the virtual network identifier and the interface identifier. The retrieved virtual stream identifier identifies a communication stream over the virtual network that is to be used for timing message.

The machine-readable instructions include time synchronization instructions 908 to perform a time synchronization process over the virtual network based on the retrieved virtual stream identifier. Timing messages of the time synchronization process are correlated to the virtual stream identifier so that a delay over the virtual network can be computed.

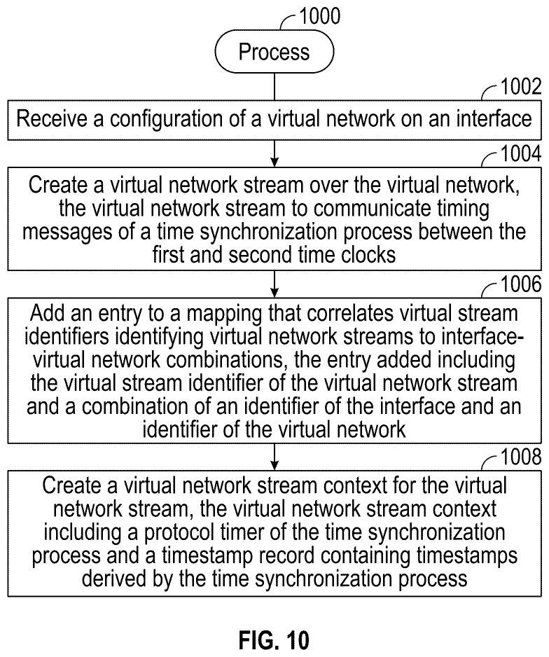

FIG. 10 is a flow diagram of a process 1000 according to some examples of the present disclosure. The process 1000 can be performed by a first electronic device including a first time clock. The first time clock is to be synchronized with a second time clock in a second electronic device.

The first electronic device receives (at 1002) a configuration of a virtual network on an interface. The configuration of the virtual network can be in response to a configuration request.

The first electronic device creates (at 1004) a virtual network stream over the virtual network, the virtual network stream to communicate timing messages of a time synchronization process between the first and second time clocks.

The first electronic device adds (at 1006) an entry to a mapping that correlates virtual stream identifiers identifying virtual network streams to interface-virtual network combinations, the entry added including the virtual stream identifier of the virtual network stream and a combination of an identifier of the interface and an identifier of the virtual network.

The first electronic device creates (at 1008) a virtual network stream context for the virtual network stream, the virtual network stream context including a protocol timer of the time synchronization process and a timestamp record containing timestamps derived by the time synchronization process.

As used here, a memory can be implemented with one or more memory devices, including any or some combination of a dynamic or static random access memory (a DRAM or SRAM) device, an erasable and programmable read-only memory (EPROM) device, an electrically erasable and programmable read-only memory (EEPROM) device, or a flash memory device.

Various flow diagrams show respective orders of tasks. In other examples, the tasks of a flow diagram can be performed in a different order, some tasks may be omitted, and other tasks may be added.

A storage medium (900 in FIG. 9) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A first electronic device comprising:
an interface to communicate over a plurality of virtual networks;
a memory to store a mapping between virtual stream identifiers and respective interface-virtual network combinations, wherein a virtual stream identifier identifies a communication stream over a virtual network of the plurality of virtual networks, and an interface-virtual network combination of the interface-virtual network combinations comprises an identifier of the interface and an identifier of a virtual network; and
a first time clock to provide time information, the first time clock to:
as part of a first time synchronization process over a first virtual network of the plurality of virtual networks, perform a lookup of the mapping using a first virtual stream identifier to retrieve an identifier of the first virtual network, the first virtual stream identifier identifying a communication stream over the first virtual network;
add the identifier of the first virtual network to a first timing message; and
send, over the first virtual network, the first timing message to a second electronic device that includes a second time clock to which the first time clock of the first electronic device is to be synchronized over the first virtual network according to the first time synchronization process.

2. The first electronic device of claim 1, wherein the first time clock is to receive, over the first virtual network, a second timing message of the first time synchronization process from the second time clock, the second timing message containing the identifier of the first virtual network.

3. The first electronic device of claim 2, wherein the first time clock is to:
perform a lookup of the mapping using the identifier of the first virtual network contained in the second timing message to retrieve the first virtual stream identifier correlated by the mapping to the identifier of the first virtual network; and
associate the second timing message with the communication stream over the first virtual network.

4. The first electronic device of claim 3, wherein the first time clock is to:
add a timestamp associated with the second timing message to a timestamp record associated with the communication stream over the first virtual network; and
use timestamps in the timestamp record to synchronize the first time clock and the second time clock over the first virtual network.

5. The first electronic device of claim 1, wherein the first time clock to send, over a second virtual network of the plurality of virtual networks, a second timing message of a second time synchronization process to a target electronic device that includes a time clock to which the first time clock of the first electronic device is to be synchronized over the second virtual network according to the second time synchronization process, wherein the second virtual network is different from the first virtual network.

6. The first electronic device of claim 1, wherein the plurality of virtual networks comprise a plurality of virtual local area networks (VLANs), and the mapping correlates the virtual stream identifiers to respective interface-VLAN combinations, wherein a virtual stream identifier identifies a communication stream over a VLAN of the plurality of VLANs, and an interface-virtual network combination of the interface-virtual network combinations comprises an identifier of the interface and an identifier of a VLAN.

7. The first electronic device of claim 6, wherein the identifier of the interface comprises an identifier of a physical port.

8. The first electronic device of claim 1, wherein the first time clock is to:
receive a configuration of the first virtual network on the interface;
responsive to the configuration of the first virtual network on the interface, create the first virtual stream identifier and add an entry to the mapping, the entry added containing the first virtual stream identifier correlated to a combination of the identifier of the interface and an identifier of the first virtual network.

9. The first electronic device of claim 8, wherein the first time clock is to initialize a timer for the first time synchronization process and create a timestamp record to store timestamps associated with the first time synchronization process.

10. The first electronic device of claim 1, comprising a timer associated with the first time synchronization process, wherein the first time clock is to:
responsive to an expiration of the timer, send a timing message of the first time synchronization process.

11. The first electronic device of claim 1, wherein the first time clock is to:
determine whether a timestamp is to be included in the first timing message;
based on determining that the timestamp is to be included in the first timing message, add metadata to the first timing message, the metadata comprising the first virtual stream identifier to be correlated to the timestamp.

12. The first electronic device of claim 11, wherein the metadata further comprises a message type of the first timing message and the identifier of the interface from which the first timing message egresses.

13. The first electronic device of claim 12, wherein the metadata further comprises a sequence identifier of the first timing message, and wherein the first time clock is to:
add the timestamp and the sequence identifier to a timestamp record for the communication stream over the first virtual network.

14. The first electronic device of claim 11, wherein the first time clock is to:
compute an offset for an end-to-end delay between the first time clock and the second time clock using the timestamp.

15. The first electronic device of claim 1, wherein the first time clock is to:
for deriving a link-level peer-to-peer delay between the first time clock and a next hop of in a network path, send a further timing message to compute the link-level peer-to-peer delay.

16. The first electronic device of claim 15, wherein the first time clock is to:
receive configuration information indicating a selected virtual network of the plurality of virtual networks to use for determining the link-level peer-to-peer delay,
wherein the further timing message is sent over the selected virtual network.

17. A non-transitory machine-readable storage medium comprising instructions that upon execution cause a first electronic device comprising a first time clock to:
receive, at the first electronic device from a second electronic device comprising a second time clock to be synchronized with the first time clock, a packet comprising a timing message, the packet containing a virtual network identifier of a virtual network, and the packet received at an interface identified by an interface identifier;
determine whether a mapping correlating virtual stream identifiers and interface-virtual network combinations contains an entry for a combination of the virtual network identifier and the interface identifier;
based on determining that the entry is present in the mapping, retrieve a virtual stream identifier from the entry that correlates the virtual stream identifier to the combination of the virtual network identifier and the interface identifier, wherein the retrieved virtual stream identifier identifies a communication stream over the virtual network; and
perform a time synchronization process over the virtual network based on the retrieved virtual stream identifier.

18. The non-transitory machine-readable storage medium of claim 17, wherein the instructions upon execution cause the first electronic device to:
record timestamps produced by the time synchronization process in a timestamp record associated with the retrieved virtual stream identifier.

19. A method comprising:
receiving, at a first electronic device comprising a first time clock to be synchronized with a second time clock of a second electronic device, a configuration of a virtual network on an interface;
creating, at the first electronic device, a virtual network stream over the virtual network, the virtual network stream to communicate timing messages of a time synchronization process between the first and second time clocks;
adding, at the first electronic device, an entry to a mapping that correlates virtual stream identifiers identifying virtual network streams to interface-virtual network combinations, the entry added comprising the virtual stream identifier of the virtual network stream and a combination of an identifier of the interface and an identifier of the virtual network; and
creating, at the first electronic device, a virtual network stream context for the virtual network stream, the virtual network stream context comprising a protocol timer of the time synchronization process and a timestamp record containing timestamps derived by the time synchronization process.

20. The method of claim 19, further comprising:
in response to unconfiguring the virtual network, deleting the entry from the mapping and removing the virtual network stream context.
